(19) United States
(12) Patent Application Publication
(10) Pub. No.: US 2015/0328849 A1
(43) Pub. Date: Nov. 19, 2015

(54) METHOD FOR INJECTION MOLDING A FASTENING ELEMENT, AND FASTENING ELEMENT

(71) Applicant: NEWFREY LLC, Newark, DE (US)

(72) Inventors: Frank ROSEMANN, Giessen (DE); Wolfgang GERLACH, Giessen (DE); Michael SCHMIDT, Giessen (DE); Siegfried LAUTNER, Giessen (DE); Ralf MICHEL, Giessen (DE)

(21) Appl. No.: 14/812,310

(22) Filed: Jul. 29, 2015

Related U.S. Application Data
(63) Continuation of application No. PCT/EP2014/051493, filed on Jan. 27, 2014.

(30) Foreign Application Priority Data
Jan. 29, 2013 (DE) 102013100849.6

(51) Int. Cl. B29D 1/00; F16B 37/00; F16B 23/00; B29C 45/00

(52) U.S. Cl. CPC B29D 1/00; B29C 45/0046; F16B 37/00; F16B 23/0061; B29L 2001/00

(57) ABSTRACT

A fastening element for holding onto a stud, the fastening element having a body extending along an axis and including a wall of substantially uniform thickness that partially defines an axially extending through hole; a sprue located only at a single axial injection end of the wall; and wherein the fastening element is formed of an injection molded liquid crystal polymer material that flowed into the body via the sprue.

### CROSS-REFERENCE TO RELATED APPLICATIONS

This application is a continuation of PCT/EP2014/051493, filed Jan. 27, 2014 which claims priority from German Patent Application No. DE102013100849.6, filed Jan. 29, 2013, the disclosures of which are incorporated herein by reference in its entirety.

### BACKGROUND OF THE INVENTION

The invention concerns a method for injection molding a fastening element from plastic by means of an injection mold that encloses a cavity, wherein the fastening element has a body extending along an axis with at least one wall that encloses a hole extending in the axial direction for accommodating a stud or the like. The invention further concerns a fastening element injection molded from plastic with a hole for accommodating a stud.

Fastening elements of the aforementioned type, especially nuts, are known from DE 298 10 428 U1, DE 100 48 975 C1 and DE 10 2005 006 592 A1. The latter document also describes a manufacturing method of the specified type. Thermoplastic materials are used for injection molding such fastening elements, but their thermal stability is limited.

### BRIEF SUMMARY OF THE INVENTION

The object of the present invention is to specify a fastening element of the said type and to specify a method for injection molding the same that can be used in an environment where relatively high temperatures, in particular 200° and above, can occur.

The said object is attained by a fastening element comprising: a body extending along an axis and including a wall of substantially uniform thickness that partially defines an axially extending through hole; a sprue located only at a single axial injection end of the wall; and wherein the fastening element is formed of an injection molded liquid crystal polymer material that flowed into the body via the sprue.

The said object is attained by a method for injection molding from plastic a fastening element comprising a body extending along an axis and including a wall of substantially uniform thickness that partially defines an axially extending through hole, and a sprue located only at a single axial injection end of the wall; and the method of injection molding includes the steps of: providing an injection mold including a cavity of uniform thickness and defining the fastener element; injecting a liquid crystal polymer material centrally into the cavity of the injection mold only at the injection end; and advancing a flow front of the liquid crystal polymer material uniformly axially into the cavity.

Further advantageous embodiments of the fastening element are specified in claims 2 through 10 and further advantageous embodiments of the method of forming the fastening element are specified in claims 12 through 18.

According to the invention, a liquid crystal polymer material (LCP) is used as the plastic in the method for injection molding a fastening element from plastic by means of an injection mold that encloses a cavity and that molds a fastening element having a body extending along an axis with a wall that encloses a hole extending in the axial direction for accommodating a stud or the like. The injection mold here is designed such that the cavity has a uniform thickness and the liquid crystal polymer material (LCP) is injected centrally into the cavity of the injection mold at an axial injection end in such a manner that the flow front of the material advances uniformly axially into the cavity. In this context, the thickness of the cavity is understood to mean the spacing of cavity walls that are directly opposite one another and that together with one another mold a wall of the fastening element. The cavity thickness thus corresponds to the thickness of the wall molded by filling the cavity.

Liquid crystal polymers are distinguished by high heat resistance, so that fastening elements molded therefrom can be used in areas with high thermal stress. However, the LCP materials used for injection molding have anisotropic properties with process-induced orientation resulting from alignment of the molecules. In order to achieve the desired molded part properties, it is thus critical to achieve a molecular orientation that is optimal for the strength requirements of the fastening element by means of the direction of flow of the material during injection. The creation of knit lines should be avoided as much as possible here, as LCP material exhibits reduced knit line strengths. It has been shown that a molecular alignment with very advantageous strength properties for a fastening element, preferably usable as a nut, can be achieved by locating the injection point at one axial end and centered with respect to the wall formed by injection molding. The injection process can be well controlled, and the creation of knit lines with reduced strength is largely avoided.

According to another proposal of the invention, central injection of the LCP material can be achieved in an especially advantageous manner by the means that a sprue that closes the hole on one side and into which the polymer material is centrally injected is formed by the injection mold at the injection end of the wall. The sprue results in a very uniform distribution of the material in the annular end of the cavity adjoining the sprue for molding the wall, and thus a uniform flow front as well. The sprue has the further advantage that only one centrally located nozzle is required for the exit of the polymer material. This considerably simplifies the manufacturing and maintenance of the injection molding tools.

So that the sprue does not hinder the complete passage through the hole of a stud inserted into the fastening element, according to another proposal of the invention the sprue can be designed to be separable by slots and/or predetermined breaking points. By this means, the stud entering the hole can separate and spread apart the sprue.

Alternatively, according to another proposal of the invention, the injection end of the cavity for molding the wall can be annular in design, with the polymer material being injected into the cavity of the injection mold by means of an annular nozzle.

According to another proposal of the invention, a flange that encloses the hole and has essentially the same thickness as the wall can be molded onto the end of the wall opposite the injection end by means of appropriate design of the injection mold. In addition, the flange can be provided at its circumferential edge with a reinforcing ring extending axially and having the same thickness as the flange.

According to another proposal of the invention, the cavity of the injection mold can be designed such that ribs extending radially outward are molded onto the outside of the wall of the body, wherein the thickness is essentially the same as the thickness of the wall. The ribs serve to reinforce the wall. Some or all ribs can be provided with end sections that are molded onto the flange and that extend radially outward to the circumferential edge of the flange. This achieves reinforcement of the flange and joining of the wall to the flange.

According to another proposal of the invention, tangentially extending reinforcing ribs can be molded onto the outer, axially extending ends of some or all ribs located on the outside of the wall in order to form a tool engagement region on the outside of the body, with the outer surfaces of the reinforcing ribs forming corner regions of a polygonal prism. This design in accordance with the invention makes it possible, by means of walls having uniform and relatively small thickness, to form a tool engagement region on the outside of the body of the fastening element with an outer diameter that is independent of the diameter of the hole and can advantageously be made large.

### BRIEF DESCRIPTION OF THE DRAWINGS

The invention is explained in detail below with reference to the exemplary, but not limiting, embodiments that are shown in the drawings, in which:

FIG. 1 is a perspective view of a first embodiment of a fastening element according to the invention.

FIG. 2 is a top view of the fastening element from FIG. 1.

FIG. 3 is a side view of the fastening element from FIG. 1.

FIG. 4 is a cross-section along line IV-IV in FIG. 2.

FIG. 5 is a cross-section along line V-V in FIG. 2.

FIG. 6 is a perspective view of a second embodiment of a fastening element according to the invention.

### DETAILED DESCRIPTION OF THE PREFERRED EMBODIMENTS

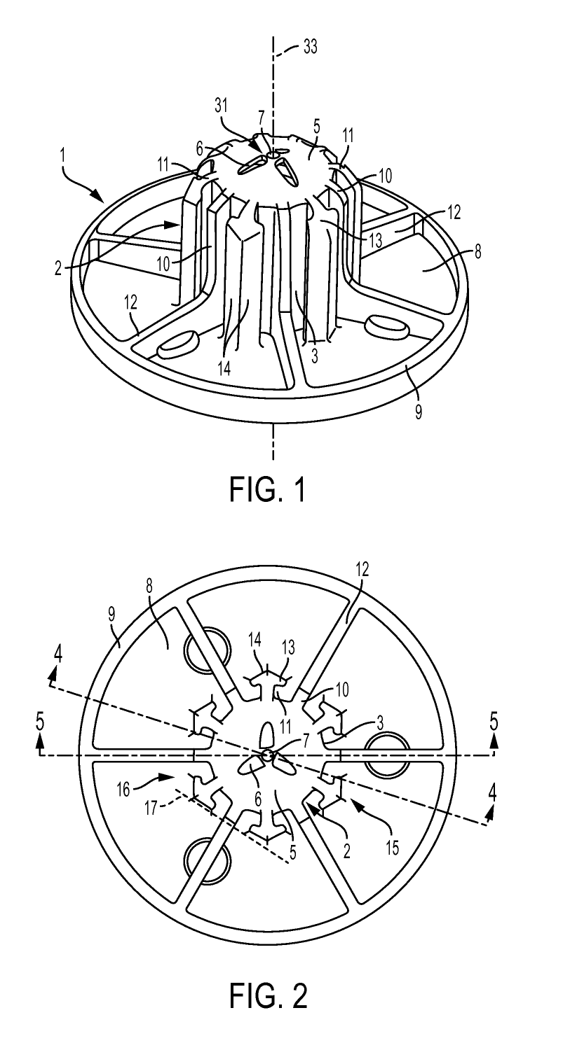

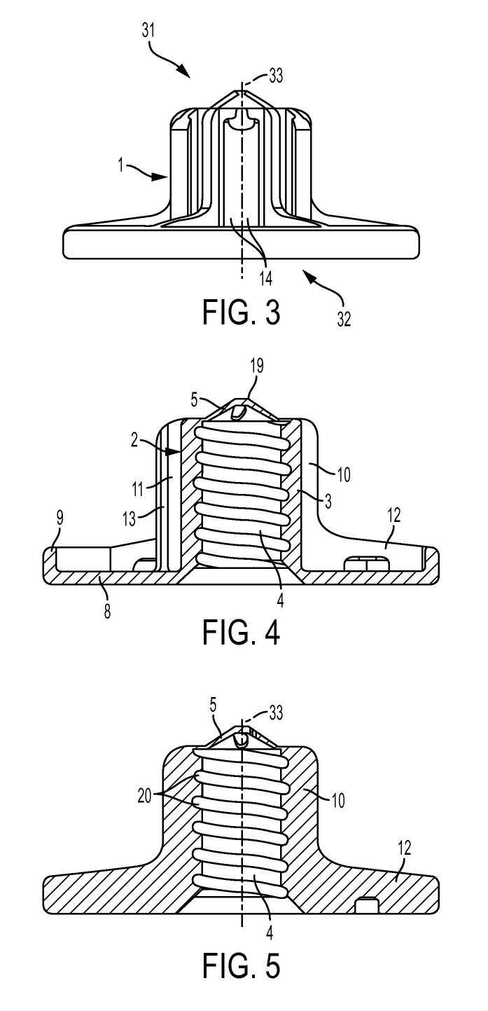

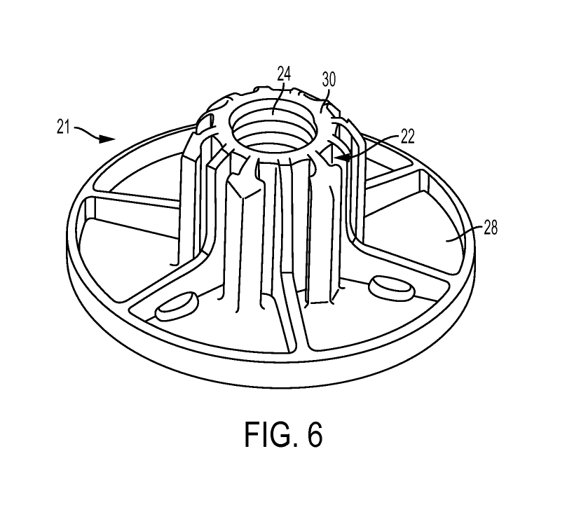

FIGS. 1 through 5 show a fastening element 1 that can be used as a nut for fastening parts to a threaded bolt. The fastening element 1 has a hollow cylindrical body 2 with a wall 3 that, as is shown in FIGS. 4 and 5, encloses a central cylindrical hole 4. The hole 4 is provided with an internal thread 20, but can also be designed to be smooth if the fastening element is to be attached to a stud (not shown) with a self-cutting thread. The first or top end 31 (or injection end) of the hole 4 in the drawing is closed by a sprue 5 whose tip 19 projects away from the body 2. The sprue 5 has a smaller wall thickness than the wall 3, and has three slots 6 arranged at uniform spacing from one another and a predetermined breaking point 7 in the center of the slots 6. The slots 6 and predetermined breaking point 7 make it possible to separate the sprue 5 while the fastening element 1 is being screwed onto a stud when the stud entering the hole 4 presses against the sprue 5 in the axial direction 32. After separation of the sprue 5, the segments of the sprue that have been separated from one another can be spread apart and pushed aside by the further advance of the stud, so that the stud can emerge unobstructed from the hole 4 at the injection end 31 of the body 2.

Molded onto the second or bottom end (32) of the body 2 opposite the sprue 5 is a flat, plate-shaped flange 8 that encloses the hole 4 in an annular fashion. The circumferential edge of the flange 8 is reinforced by a reinforcing ring 9 that projects from the flange 8 at its top side facing the body.

Ribs 10, 11 extending in the axial direction and radially outward are located at uniform intervals from one another on the outside of the wall 3. Adjacent to the flange 8, the first ribs 10 are provided with extensions 12 that extend radially outward to the reinforcing ring 9 and are connected thereto. The first ribs 10 and the extensions 12 reinforce the connection between the wall 3 and the flange 8, and increase the stiffness of the flange 8.

The second ribs 11 are in each case located between the ribs 10, and at their radially outer edges carry reinforcing ribs 13 that extend in the tangential direction on both sides of the ribs 11 at a distance from the wall 3. The outer surfaces 14 of the reinforcing ribs 13 form corner regions 15 of a polygonal prism 16, here a hexagonal prism. This creates a tool engagement region 16 with an advantageously large outer diameter D. The ribs 10 have a radial width W in the region provided for tool engagement such that their end faces lie in a common plane 17 with the outer surfaces 14 of their respective adjacent reinforcing ribs 13.

Because of its design, the fastening element 1 is especially suitable for manufacture from a liquid crystal polymer material, in particular from a high-molecular-weight, thermotropic LCP material in an injection molding process. All sections of the fastening element 1, such as the wall 3, flange 5, reinforcing ring 9 and the various ribs 10, 11, and 13, have an essentially uniform, relatively small thickness. Moreover, they are arranged such that with central injection of the material into the tip 19 of the sprue 5, the flow front advances uniformly into the injection mold, avoiding knit lines where material joins from opposite directions. Central injection also results in a molecular alignment that can be expected to result in favorable strength values for meeting the requirements the fastening element is subject to in use. Consequently, forces that arise in the fastening of parts by screwing the fastening element 1 onto a stud can be accommodated well.

The described design of the fastening element 1 and the method for its manufacture by injection molding are also suitable for manufacture of the fastening element 1 from fiber-reinforced plastic, since the fibers likewise take on a prevailing alignment in the axial and radial directions.

FIG. 6 shows a variant embodiment of a fastening element 21 that differs from the fastening element 1 in that the hole 24 passing through the body 22 is fully open at the injection end facing away from the flange 28. Instead, the body 22 forms an annular surface 30 at the injection end where the material can be injected into the injection mold with the aid of an annular nozzle for primary molding of the fastening element 21. In the surface of the injection mold that molds the annular surface 30, the annular nozzle has a concentric annular gap with a width that is constant but smaller than the width of the annular surface 30. During the injection molding process, the LCP material exits the annular gap uniformly in the shape of a tube and fills the injection mold with a uniformly advancing flow front. Aside from the difference in the design of the injection means, the injection molding process and the properties of the fastening element 21 that are achievable therewith correspond largely to those described above in connection with the fastening element 1.

Although exemplary embodiments of the present invention have been shown and described, it will be appreciated by those skilled in the art that changes may be made to these embodiments without departing from the principles and spirit of the invention, the scope of which is defined in the appended claims and their equivalents.

What is claimed is:

1. A fastening element for holding onto a stud, the fastening element comprising:
a body extending along an axis and including a wall of substantially uniform thickness that partially defines an axially extending through hole;
a sprue located only at a single axial injection end of the wall; and
wherein the fastening element is formed of an injection molded liquid crystal polymer material that flowed into the body via the sprue.

2. A fastening element according to claim 1, and further comprising a flange extending radially from adjacent a second axial end of the wall opposite the sprue, the flange having substantially the same thickness as the wall.

3. A fastening element according to claim 2, wherein the flange includes a reinforcing ring located at and projecting axially from a circumferential edge of the flange.

4. A fastening element according to claim 3, wherein the sprue substantially closes the through hole at the injection end, and the sprue includes at least one of a slot and a predetermined breaking point.

5. A fastening element according to claim 3, wherein the sprue includes an annular surface surrounding the through hole at the injection end of the body.

6. A fastening element according to 1, wherein the body further includes a rib extending radially outward and axially along the outside of the wall, the rib having a thickness substantially equal to the thickness of the wall.

7. A fastening element according to claim 6, wherein the rib is a plurality of ribs, and the plurality of ribs include at their radial outer ends a tangentially extending reinforcing rib, and an outer surface of the reinforcing rib forms a corner region of a polygonal prism partially defined by an radially outward ends of the plurality of ribs in radial cross section, and the polygonal prism is operable as a tool engagement region for the fastening element.

8. A fastening element according to claim 7, wherein the sprue substantially closes the through hole at the injection end, and the sprue includes at least one of a slot and a predetermined breaking point.

9. A fastening element according to claim 7, wherein the sprue includes an annular surface surrounding the through hole at the injection end of the body.

10. A fastening element according to claim 6, and further comprising a flange extending radially from adjacent a second axial end of the wall opposite the injection end, and wherein the rib includes a radial extension extending from adjacent the second axial end of the rib radially along and molded onto the flange to a circumferential edge of the flange.

11. A method for injection molding from plastic a fastening element comprising a body extending along an axis and including a wall of substantially uniform thickness that partially defines an axially extending through hole, and a sprue located only at a single axial injection end of the wall; and the method of injection molding includes the steps of:
providing an injection mold including a cavity of uniform thickness and defining the fastener element;
injecting a liquid crystal polymer material centrally into the cavity of the injection mold only at the injection end; and
advancing a flow front of the liquid crystal polymer material uniformly axially into the cavity.

12. A method according to 11, and further comprising a step of molding a flange onto a second end of the wall opposite the injection end, the flange surrounding the through hole and of substantially the same thickness as the wall.

13. A method according to claim 12, and further comprising a step of molding an axially extending reinforcing ring onto a circumferential edge of the flange.

14. A method according to claim 11, and further comprising a step of molding a rib extending axially along and radially outward from the wall of the body, and the thickness of the rib is substantially the same thickness as the wall.

15. A method according to claim 14, and further comprising the steps of:
molding a flange onto a second end of the wall opposite the injection end, the flange surrounding through the hole and of substantially the same thickness as the wall; and
molding an extension to the rib and the flange, the extension extending from adjacent the second axial end of the rib radially along the flange to a circumferential edge of the flange.

16. A method according to claim 14, and further comprising the step of molding a tangentially extending reinforcing rib to a radially outer end of the rib.

17. A method according to claim 11, wherein the injecting step of the method includes injecting the liquid crystal polymer material into the cavity via the sprue, and the sprue substantially closes the through hole at the injection end.

18. A method according to claim 11, wherein the injecting step of the method includes injecting the liquid crystal polymer material into the cavity with an annular nozzle and via the sprue, and the sprue includes an annular surface surrounding the through hole at the injection end of the body.
